(19) United States
(12) Patent Application Publication
(10) Pub. No.: US 2026/0366181 A1
(43) Pub. Date: Nov. 19, 2026

(54) SOLID OXIDE ELECTROLYZER WITH STACK MODULE AND METHOD OF EXCHANGING STACK MODULE OF SOLID OXIDE ELECTROLYZER

(71) Applicant: Topsoe A/S, Kgs. Lyngby (DK)

(72) Inventors: Michael Boe, Klampenborg (DK); Anders Helbo Hansen, Espergærde (DK); Klaus Risbjerg Jarlkov, Køge (DK)

(73) Assignee: Topsoe A/S, Kgs. Lyngby (DK)

(21) Appl. No.: 19/124,044

(22) PCT Filed: Oct. 20, 2023
(86) PCT No.: PCT/EP2023/079307

§ 371 Date: Apr. 24, 2025

(30) Foreign Application Priority Data
Oct. 27, 2022 (EP) 22204112.1

(51) Int. Cl. C25B 15/08; C25B 9/05; C25B 9/19; C25B 9/60; C25B 9/70; C25B 13/07

(52) U.S. Cl. CPC C25B 15/08; C25B 9/05; C25B 9/19; C25B 9/60; C25B 9/70; C25B 13/07

(57) ABSTRACT

The present invention relates to stack module with at least one Solid Oxide electrolysis stack that comprises a plurality of stacked Solid Oxide electrolysis cells, wherein the stack module comprises two gas inlet connections and two gas outlet connections. According to the invention, the at least one Solid Oxide electrolysis stack is encapsulated in a metal container, wherein the two gas inlet connections and the two gas outlet connections are attached to the metal container. The invention further relates to Solid Oxide Electrolyzer with at least one stack module and a method of exchanging a stack module of a Solid Oxide Electrolyzer.

The present invention relates to a stack module, a Solid Oxide Electrolyzer with a stack module and a method of exchanging a stack module of a Solid Oxide Electrolyzer.

A stack module comprises at least one Solid Oxide electrolysis stack that comprises a plurality of stacked Solid Oxide electrolysis cells, wherein the stack module comprises two gas inlet connections and two gas outlet connections.

Currently known Solid Oxide Electrolyzers with stack modules have so far been designed for small production capacity and mostly for lab scale or small technology demonstration units. These Solid Oxide Electrolyzers are operated by Solid Oxide electrolysis specialists in a controlled environment, as the Solid Oxide electrolysis cells are highly sensitive.

To upscale the Solid Oxide Electrolyzers to large scale industrial production further improvements are needed to improve serviceability and maintainability in the field of the Solid Oxide Electrolyzer and its stack modules, which have shorter live times than other components of the Solid Oxide Electrolyzer.

Therefore, the object of the present invention is to provide an improved Solid Oxide Electrolyzer and stack module.

A solution of the object according to the invention exists if the at least one Solid Oxide electrolysis stack is encapsulated in a metal container, wherein the two gas inlet connections and the two gas outlet connections are attached to the metal container.

By encapsulating the Solid Oxide electrolysis stack in the metal container, the fragile Solid Oxide electrolysis stack is protected from impact and contamination. Further, the complex installation work of the sensitive and easy-to-break Solid Oxide electrolysis cells in to Solid Oxide electrolysis stacks and then into the stack modules can be done in specialized manufacturing factories at the Solid Oxide electrolysis plant supplier in a quality controlled environment. The stack module is then a robust component that can be easily handled by mechanical plant workers available locally at the customers Solid Oxide electrolysis plant. Therefore, the stack module according to the invention greatly improves the serviceability and maintainability of a Solid Oxide Electrolyzers with at least one stack module.

According to a particularly preferred embodiment, the two gas inlet connections and the two gas outlet connections each comprise hot quick couplings to connect them to external gas inlets or outlets. Thereby, hot quick couplings relate to bolted connections, compression fitting style connections, piping unions, threaded connections, wedged connections, tight fit connections, or similar known high temperature quick coupling solutions for piping. By using hot quick couplings, the stack module can be exchanged quickly and efficiently from the respective Solid Oxide Electrolyzer. For this, no Solid Oxide electrolysis specialists are needed at the plant site. Preferably, the hot quick couplings are configured as piping unions. This way, a very secure connection can be achieved in a short time frame.

According to a preferred embodiment, the Solid Oxide electrolysis stack is configured to produce hydrogen, carbon monoxide or syngas. Preferably, a temperature regime in the Solid Oxide electrolysis stack is kept between 500 °C and 850 °C during the production of hydrogen, carbon monoxide or syngas.

According to a preferred embodiment, the stack module comprises two Solid Oxide electrolysis stacks, which are manifolded by a shared manifold, which is part of the metal container and to which the two gas inlet connections and the two gas outlet connections are attached. By including two Solid Oxide electrolysis stacks into one stack module the overall production capacity of one stack module can be increased. Further, the stack module is still not too big to be easily handled. By using a shared manifold, the number of necessary components can be decreased. The same applies for the shared manifold being part of the metal container.

According to another preferred embodiment, the two Solid Oxide electrolysis stacks are placed within respective encapsulating shrouds that form the metal container in combination with the shared manifold and with two lids that are placed in one of the encapsulating shrouds respectively to enclose the Solid Oxide electrolysis stack in the encapsulating shroud. This construction of the metal container is simple and efficient to manufacture. In addition, Solid Oxide electrolysis stacks of different heights can be encapsulated inside the same encapsulating shroud by adjusting the position of the lid in the respective encapsulating shroud. Preferably, the encapsulating shrouds are cylindrical and open towards both ends, wherein one of the ends can be fixed to the shared manifold.

In a further preferred embodiment, gaskets are placed between the two Solid Oxide electrolysis stacks and the shared manifold and ceramic fiber mats are placed between the two Solid Oxide electrolysis stacks and the respective lid in the encapsulating shroud, wherein the lid is fixated to a position in the encapsulating shroud, preferably by welding, and the ceramic fiber mat is configured to exert a compression force onto the respective Solid Oxide electrolysis stack and thereby onto the respective gasket and the shared manifold. This way, the Solid Oxide Electrolysis stack is pressed against the gasket and therefore against the shared manifold. Hereby, the position of the lid in the encapsulating shroud and the properties of the ceramic fiber mat can be configured in a way that the sealing of the gasket between the shared manifold and the Solid Oxide electrolysis stack is kept functional even during different temperature regimes. Preferably, the exact position of the lid is found by exerting a certain pressure on the lid and thereby on the ceramic fiber mat, Solid Oxide Electrolysis stack, gasket and shared manifold, which results in the right compression of the ceramic fiber mat, Solid Oxide Electrolysis stack and gasket. The lid can then be fixed in this position by welding.

In a particularly preferred embodiment, the two Solid Oxide electrolysis stacks are arranged on opposite sides of the shared manifold, wherein the two Solid Oxide electrolysis stacks are preferably configured symmetrically towards a symmetry plane trough the shared manifold, which is perpendicular to axes of the encapsulating shrouds, wherein the shared manifold is preferably also constructed symmetrically to the symmetry plane. This arrangement allows a compact design of the stack module. Further, the distances the educt or product gases have to travel in the manifold can be kept short. Another advantage is that, when the lids are pressed onto the respective ceramic fiber mat, Solid Oxide Electrolysis stack, gasket and shared manifold from opponent directions, the shared manifold does not experience any deflection, because the forces on the shared manifold cancel each other out. Hence, the shared manifold can be designed thinner without manifold deflection and the risk of sealing issues between the Solid Oxide electrolysis stacks and the shared manifold.

According to another preferred embodiment, each stacked Solid Oxide electrolysis cell comprises two sides, an anode and a cathode side, wherein the two sides are suppliable with different gas streams and wherein the stacked Solid Oxide electrolysis cells are separated by gastight division plates, wherein the shared manifold comprises respective first gas inlets for the two Solid Oxide electrolysis stacks that are supplied by a first of the two gas inlet connections and that lead a first gas stream into respective voids between the encapsulating shrouds and the Solid Oxide electrolysis stacks, wherein the first gas stream then enters volumes between one of the two sides of the respective Solid Oxide electrolysis cells and the respective adjacent division plate and then travels through the volumes towards a centrally placed hole in the respective Solid Oxide electrolysis stack, from where the first gas stream exits the shared manifold through a respective first gas outlet, which is connected to a first of the two gas outlet connections, wherein the shared manifold further comprises second gas inlets for the two Solid Oxide Electrolysis stacks, which are suppliable by a second of the two gas inlet connections with a second gas stream that is lead into a respective hole in the respective Solid Oxide electrolysis stack that extends up through a full stack height, from which the second gas stream enters other volumes between the other side of two sides of the Solid Oxide electrolysis cells and the respective adjacent division plate and then transfers through the other volumes to another hole in the full stack height, from which the second gas stream exits the shared manifold through a second gas outlet, which is connected to a second of the two gas outlet connections. This is an efficient way of supplying the Solid Oxide electrolysis cells with the educt gases and of leading away the product gases.

The invention further relates to a Solid Oxide Electrolyzer comprising a pressure shell and a hot zone insulation within the pressure shell, wherein the hot zone insulation surrounds a hot zone, in which at least one stack module, preferably according to one of the embodiments of the stack module described above, with stacked Solid Oxide electrolysis cells is positioned, wherein the pressure shell comprises a lower pressure shell part and an upper pressure shell part that are connected by a pressure shell flange connection, and wherein the hot zone insulation comprises an insulation bell and a static insulation part, wherein external connections including electrical connections, educt gas piping and product gas piping are let through the lower pressure shell part and not through the upper pressure shell part, such that the upper pressure shell part can be lifted from the lower pressure shell part upon opening of the pressure shell flange connection without further disconnection work, and wherein the electrical connections and the product gas piping are let through the static insulation part and not through the insulation bell, such that the insulation bell can be lifted without disconnection work regarding the electrical connections and the product gas piping, when the upper pressure shell part is removed.

This way, the serviceability and maintainability of the Solid Oxide Electrolyzer is greatly improved, as the dismantling can be performed very efficient. Further, by not using an insulation of individual components, the accessibility to the components can be improved and the insulation does not have to be replaced together with the components, but can continue to be used. This is particularly advantageous because the hot zone insulation has a significantly longer service life than the stack modules.

Electrical connections relate to electrical power connections for the stack modules and to electrical power connections for heaters. Preferably, the external connections also comprises connections for further instrumentation and data collection. These connections for further instrumentation and data collection are preferably let trough the lower pressure shell part and the static insulation part, such that the upper pressure shell part and the insulation bell can be lifted away without disconnection work of the connections for further instrumentation and data collection.

In a preferred embodiment, the external connections are let through the static insulation part and not through the insulation bell, such that the insulation bell can be lifted away without disconnection work, when the upper pressure shell part is removed.

In a preferred embodiment, the Solid Oxide Electrolyzer comprises a plurality of stack modules, wherein the Solid Oxide Electrolyzer has a capacity of at least 0,3 MW, preferably at least 0,5 MW. By using this size of Solid Oxide Electrolyzer, the output of the Solid Oxide Electrolyzer is suitable for industrial hydrogen, carbon monoxide or syngas production.

Preferably, the Solid Oxide Electrolyzer comprises six stack modules that are arranged around a shared axis of the upper pressure shell part and the insulation bell.

In a preferred embodiment, the insulation bell is open downwards. This way the insulation bell encloses a certain volume which is exposed and easily accessible, when the insulation bell is lifted away. The insulation bell can be formed of several parts that can be lifted away after each other. Preferably, the insulation bell is however made up of one integral piece. Thereby, the lifting of the insulation bell requires less time and is more efficient.

In another preferred embodiment, heat exchangers between educt gases and product gases and heaters for the educt gases are arranged inside the hot zone.

In another preferred embodiment, the insulation bell is gas tight and structurally stable in itself, wherein the insulation bell preferably consist of a gas tight inner liner, an insulation material layer and an outer structural layer or of a structural stable insulation material, preferably a ceramic lightweight castable, from which the insulation bell is made entirely. These are advantageous designs that allow for a durable insulation bell.

Yet according to another preferred embodiment, a position of the static insulation part is fixed in relation to a position of the lower pressure shell part, wherein a hot zone insulation gasket is arranged on the static insulation part onto which the insulation bell is placed and by which the hot zone is gas tight insulated. This way the insulation bell seals the hot zone insulation by its own weight resting on the hot zone insulation gasket.

In a further preferred embodiment, the pressure shell flange is located at a highest diameter of the Solid Oxide Electrolyzer and preferably at or below the position of the hot zone insulation gasket. Thereby, the interior of the hot zone can be exposed fully to perform service and maintenance work.

In a preferred embodiment, the Solid Oxide Electrolyzer comprises a recuperating space arranged at least partly around the outside of the hot zone insulation, wherein a first part of the educt gas piping being let through the lower pressure shell part introduces a first educt gas into the recuperating space and wherein the first educt gas exits the recuperating space via a snorkel into a second part of the educt gas piping that leads to the stack module in the hot zone through the static insulation part. This make the Solid Oxide Electrolyzer more energy efficient and further the pressure shell does not have to experience excessive temperatures.

In one preferred embodiment, the snorkel extends from a connection to the second part of the educt gas piping along and distant from the outside of the hot zone insulation through the recuperating space to a point at or above a top height of the hot zone insulation. This way, the insulation bell can be lifted away without further disconnection work, when the upper pressure shell part is removed.

In another preferred embodiment, the snorkel is led from the connection to the second part of the educt gas piping into the insulation bell and through the insulation bell to the top height of the hot zone insulation, where the snorkel exits the insulation bell into the recuperating space. This way, the position, where the snorkel exits the insulation bell, can be placed at an axis of the insulation bell, which leads to advantageous gas flow characteristics in the recuperating space and therefore to improved cooling. Only the connection between the snorkel and the second part of the educt gas piping needs to be opened, to be able to lift of the insulation bell, when the upper pressure shell part is removed. Preferably, the connection between the snorkel and the second part of the educt gas piping is configured as a flange connection. This way, the connection can be opened quickly and efficiently.

According to another preferred embodiment, the at least one stack module comprises two gas inlet connections and two gas outlet connection each comprising hot quick couplings, wherein the hot quick couplings are attached to gas connections inside the hot zone, which lead the process gases to and from the at least one stack module. With the hot quick couplings the serviceability and maintainability is further improved, as the stack module exchange is further facilitated.

The invention also relates to a method of exchanging a stack module of a Solid Oxide Electrolyzer according to one of the embodiments described above, wherein the method comprises the steps of disconnecting the upper pressure shell part from the lower pressure shell part by opening the pressure shell flange connection, lifting the upper pressure shell part away from lower pressure shell part and thereby exposing the insulation bell, lifting the insulation bell away and thereby exposing the stack module, disconnecting the stack module from all connections to the Solid Oxide Electrolyzer, replacing the stack module, reconnecting the stack module with the connections to the Solid Oxide Electrolyzer, closing the Solid Oxide Electrolyzer by repositioning the insulation bell and the upper pressure shell.

By this method, the stack module can be exchanged time and cost efficiently, as the exchange requires a minimum of disconnection work, can be performed without Solid Oxide electrolysis specialists and except the stack module the components can be reused, especially the insulation.

In a preferred embodiment of the method, the stack module comprises two gas inlet connections and two gas outlet connections with hot quick couplings, wherein the step of disconnecting the stack module from all connections to the Solid Oxide Electrolyzer includes decoupling the hot quick couplings of the two gas inlet connections and the two gas outlet connections and wherein the step of reconnecting the stack module with the connections to the Solid Oxide Electrolyzer includes coupling of the hot quick couplings of the two gas inlet connections and the two gas outlet connections. The hot quick couplings further improve the time efficiency of the method.

Embodiments of the present invention shall be explained in more detail hereinafter with reference to the drawings.

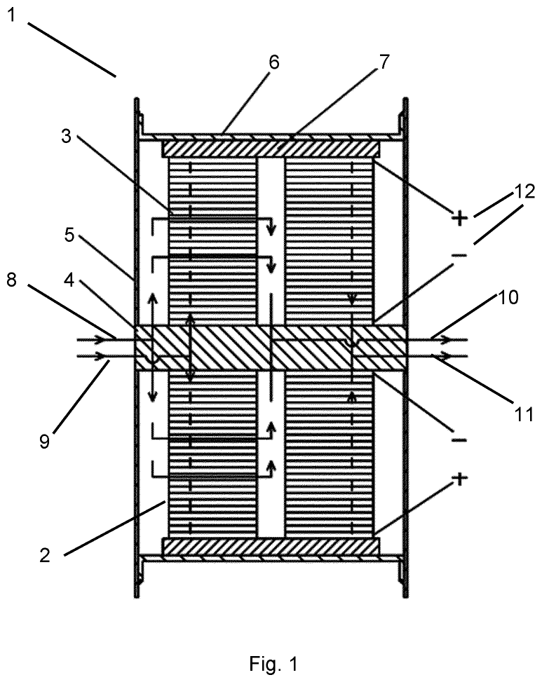

FIG. 1 shows an axial section through a stack module according to an embodiment of the present invention,

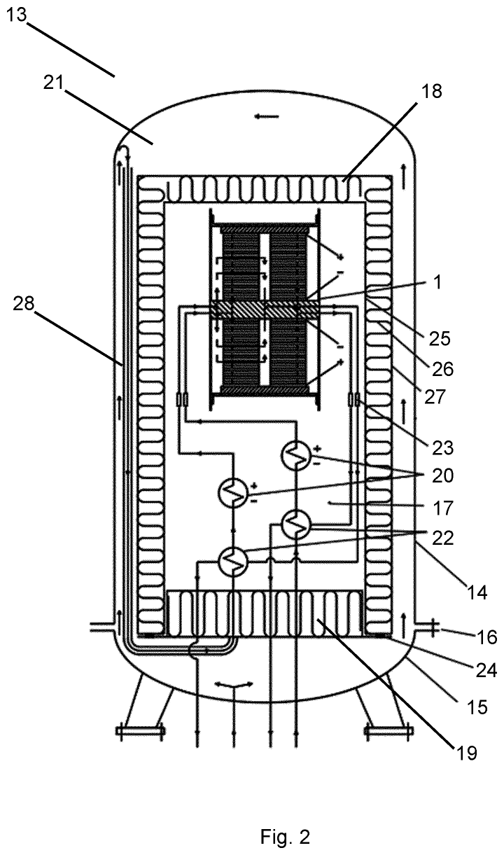

FIG. 2 shows an axial section through a Solid Oxide Electrolyzer according to a first embodiment of the present invention with a stack module according to the embodiment shown in FIG. 1,

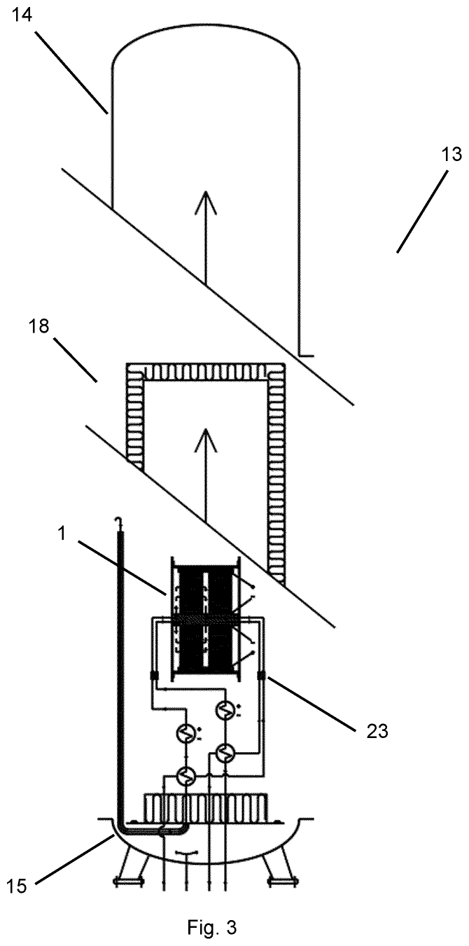

FIG. 3 shows schematic explosion view of the axial section through the Solid Oxide Electrolyzer shown in FIG. 2 illustrating the method of replacing a stack module of the Solid Oxide Electrolyzer according to the invention, and

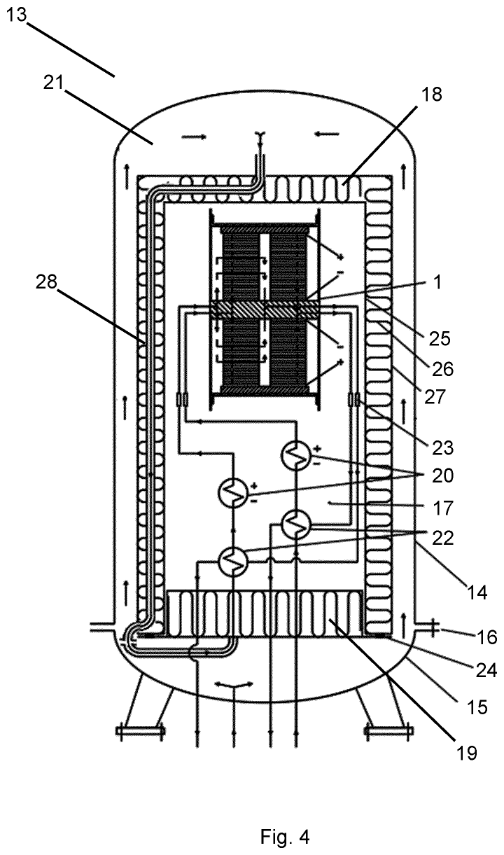

FIG. 4 shows an axial section through a Solid Oxide Electrolyzer according to a second embodiment of the present invention with a stack module according to the embodiment shown in FIG. 1.

An axial section through an embodiment of a stack module 1 according to the invention is shown in FIG. 1. The stack module 1 comprises two Solid Oxide electrolysis stacks 2 that are built up by a plurality of stacked Solid Oxide electrolysis cells 3. The two Solid Oxide electrolysis stacks 2 are arranged on opposite sides of a symmetrical shared manifold 4, wherein not shown gaskets are placed between the respective Solid Oxide electrolysis stack 2 and the shared manifold 4. The two Solid Oxide electrolysis stacks 2 are encapsulated in two encapsulating shrouds 5 that form a metal container in combination with the shared manifold 4 and two lids 6. The two lids 6 are thereby positioned in the respective encapsulating shroud 5 at an opposite end of the end of the respective Solid Oxide electrolysis stack 2 positioned at the shared manifold 4. Between the lid 6 and the Solid Oxide electrolysis stack 2 a ceramic fiber mat 7 is placed. By fixing the position of the lid 6 relative to the shared manifold 4 by welding during a certain pressure on both lids 6 from opposite sides, the ceramic fiber mat 7 is compressed and functions as spring that maintains a certain pressure on the Solid Oxide electrolysis stacks 2 and thereby on the not shown gaskets. As the encapsulating shrouds 5 and the Solid Oxide electrolysis stacks 2 have different thermal expansion coefficients, the ceramic fiber mat 7 ensures that the sealing by the gasket between the Solid Oxide electrolysis stacks 2 and the shared manifold 4 is ensured for different temperature regimes.

The stack module 1 further comprises two gas inlet connections 8, 9 and two gas outlet connections 10, 11 that are attached to the shared manifold 4. In FIG. 1 the gas streams through the stack module 1 are indicated by arrows. A first gas stream enters the shared manifold 4 through a first of the two gas inlet connections 8, wherein the first gas stream exits the manifold 4 by first gas inlets that lead into respective voids between the encapsulating shrouds 5 and the Solid Oxide electrolysis stacks 2. The Solid Oxide electrolysis cells 3 comprise two sides, an anode and cathode side, wherein the Solid Oxide electrolysis cells 3 are separated by gastight division plates. The first gas stream enters from the respective void into volumes between one of the two sides of the respective Solid Oxide electrolysis cells 3 and the respective adjacent division plates and then travels through the volumes towards a centrally placed hole in the respective Solid Oxide electrolysis stack 2, from where the first gas stream exits the shared manifold 4 through a respective first gas outlet in the centrally placed hole, which is connected to a first of the two gas outlet connections 10.

A second gas stream enters the shared manifold 4 through a second of the two gas inlet connections 9, wherein the second gas stream exits the shared manifold 4 by second gas inlets that lead into respective holes in the respective Solid Oxide electrolysis stack 2 that extend up over a full stack height, from which the second gas stream enters other volumes between the other side of two sides of the Solid Oxide electrolysis cells 3 and the respective adjacent division plate and transfers through the other volumes to another hole in the full stack height, from which the second gas stream exits the shared manifold through a second gas outlet, which is connected to a second of the two gas outlet connections 11.

In addition, the stack module 1 comprises four power connections 12 that are connected to the Solid Oxide electrolysis stacks 2 to supply power to them.

FIG. 2 shows an axial section of a Solid Oxide Electrolyzer 13 according to a first embodiment of the invention with a stack module 1 according to the embodiment shown in FIG. 1. FIG. 2 is only schematic, as the Solid oxide electrolyser 13 preferably comprises a plurality of stack modules 1. For example, six stack modules 1 that are arranged in a circle around an axis of the Solid Oxide Electrolyzer 13. Further, the gas flow as well as educt gas piping and product gas piping are only shown schematically as black arrows in FIGS. 2, 3 and 4. The Solid Oxide Electrolyzer 13 comprises a pressure shell that is divided into an upper pressure shell part 14 and a lower pressure shell part 15 that are connected by a pressure shell flange connection 16. Inside the pressure shell a hot zone insulation is arranged, wherein the hot zone insulation surrounds a hot zone 17 in which the stack module 1 is placed and wherein the hot zone insulation is divided into an insulation bell 18 and a static insulation part 19. In this embodiment, all external connections like the educt gas piping, the product gas piping, electrical power connections for the stack modules, electrical power connections for heaters 20 and connections for further instrumentation and data collection to the Solid Oxide Electrolyzer 13 are lead through the lower pressure shell part 15 and in case they enter the hot zone 17 through the static insulation part 19 and not through the upper pressure shell part 14 and the insulation bell 18. This way the upper pressure shell part can be lifted off the lower pressure shell part 15, when the pressure shell flange connection 16 is opened. The pressure shell flange connection 16 is thereby located at the widest diameter of the pressure shell and at the same height as the static insulation part 19. Therefore the entire insulation bell 18 is exposed, when the upper pressure shell part 14 is lifted off.

The insulation bell 18 is an integral component that is open downwards and is placed onto a hot zone insulation gasket 24, which is arranged at the static insulation part 19. This way the hot zone is sealed by the hot zone insulation gasket 24 by the weight of the insulation bell 18. The insulation bell 18 of this embodiment is build up by three layers, a gas tight inner liner 25, an insulation material layer 26 and an outer structural layer 27. With these layers, the insulation bell 18 is gas tight, well insulating and rigid. As no connection are led through the insulation bell 18, the insulation bell 18 can lifted off the hot zone insulation gasket in one piece, when the upper pressure shell part 14 is lifted off. By lifting off the insulation bell 18, the stack module 18 is exposed and can for example be exchanged.

The Solid Oxide Electrolyzer 13 further comprises a recuperating space 21, which surrounds the hot zone insulation. One of the educt gas streams is led into the recuperating space 21 by a first part of the educt gas piping being let through the lower pressure shell part 15 to recuperate heat from the hot zone insulation and is then led into a snorkel 28 that is connected by a connection to a second part of the educt gas piping, which leads the one of the educt gas streams into the hot zone 17 through the static insulation part 19. The snorkel 28 leads from the connection to the second part of the educt gas piping through the recuperating space 21 between the upper pressure shell part 14 and the insulation bell 18 to a point above the insulation bell 18, where the one of the educt gas streams enters the snorkel 28 from the recuperating space 21. Another one of the educt gas streams is directly led into the hot zone 17 through the lower pressure shell part 15 and the static insulation part 19. In the hot zone 17, the two educt gas streams are lead through heat exchangers 22 to exchange heat with the two product gas streams and are then lead through two heaters 20 to be heated to the reaction temperature. The educt gas streams are then led into the stack module 1 via the two gas inlet connections of the stack module 1, wherein the two gas inlet connections are connected to the educt gas piping by hot quick couplings 23, by which also the two gas outlet connections of the stack module 1 are connected to the following product gas piping not related to the stack module 1.

FIG. 3 shows schematic explosion view of the axial section through the Solid Oxide Electrolyzer 13 shown in FIG. 2 illustrating the method of replacing a stack module 1 of the Solid Oxide Electrolyzer 13 according to the invention. As the stack modules 1 in a Solid Oxide Electrolyzer 13 have a shorter life-span then other components, as, for example, the pressure shell, the hot zone insulation, heaters 20 and heat exchanger 22, the exchange of a stack module 1 has to be performed several times during the life span of the Solid Oxide Electrolyzer 13. To decrease downtime and to facilitate maintainability, this process has to simple, quick and efficient. This is achieved by the method according to the invention. After opening the pressure shell flange connection 16, the first step of the method is the lift off of the upper pressure shell part 14. As no external connections are led through the upper pressure shell part 14, this can be done without further disconnecting work and therefore very efficiently. By the lift off of the upper pressure shell part 14, the insulation bell 18 is fully exposed and can be lifted off easily as well as the next step, since no connections are lead through it for the first embodiment of the Solid Oxide Electrolyzer 13. Thereby the stack module 1 is fully exposed. By separating the gas connections from the gas inlet connections 8, 9 and gas outlet connection 10, 11 of the stack module 1 by opening the hot quick couplings 23 and by separating further connections, as for example, the power supply connections from the stack module 1, the stack module 1 can be separated from the rest of the Solid Oxide Electrolyzer 13 and be lifted away from its position in the hot zone 17. As the connection between the stack module 1 and the rest of the Solid Oxide Electrolyzer 13 are simple and easy to open and since the metal container of the stack module 1, this is easily done without Solid Oxide electrolysis specialists. Since the new stack module 1 is also supplied in its metal container and with hot quick couplings 23, the stack module 1 is ready to be built in the Solid Oxide Electrolyzer 13. For this, the new stack module 1 is placed in the position of the removed stack module 1 and the connections to the rest of the Solid Oxide Electrolyzer 13 are reconnected. Then the insulation bell 18 is replaced to seal the hot zone 17 and afterwards the pressure shell upper part 14 can be repositioned around the insulation bell 18. By closing the pressure shell flange connection 16, the method of replacing the stack module 1 is finished.

FIG. 4 shows an axial section of a Solid Oxide Electrolyzer 13 according to a second embodiment of the invention with a stack module 1 according to the embodiment shown in FIG. 1. The only difference to the first embodiment of the Solid Oxide Electrolyzer 13 according to FIG. 2 results from the different arrangement of the snorkel 28 and resulting changes. The snorkel 28 leads from its connection to the second part of the educt gas piping into the insulation bell 18 and through the insulation bell 18 to the top height of the insulation bell 18, where the snorkel 28 exits the insulation bell 18 into the recuperating space 21 at a position on the axis of the insulation bell 28. The connection between the second part of the educt gas piping and the insulation bell 18 is configured as a flange connection. When the upper pressure shell part 14 is removed, this flange connection has to be opened to be able to lift of the insulation bell 18. Further, disconnection work is not necessary.

### LIST OF REFERENCE SIGNS

1 Stack module
2 Solid Oxide electrolysis stack
3 Solid Oxide electrolysis cell
4 Shared manifold
5 Encapsulating shroud
6 Lid
7 Ceramic fiber mat
8 First of the gas inlet connections
9 Second of the gas inlet connections
10 First of the gas outlet connections
11 Second of the gas outlet connections
12 Power connections
13 Solid Oxide Electrolyzer
14 Upper pressure shell part
15 Lower pressure shell part
16 Pressure shell flange connection
17 Hot zone
18 Insulation bell
19 Static insulation part
20 Heater
21 Recuperating space
22 Heat exchanger
23 Hot quick coupling
24 Hot zone insulation gasket
25 Gas tight inner liner
26 Insulation material layer
27 Outer structural layer
28 Snorkel

1. Solid Oxide Electrolyzer comprising a pressure shell and a hot zone insulation within the pressure shell, wherein the hot zone insulation surrounds a hot zone, in which at least one stack module with stacked Solid Oxide electrolysis cells is positioned, wherein the pressure shell comprises a lower pressure shell part and an upper pressure shell part that are connected by a pressure shell flange connection, and wherein the hot zone insulation comprises an insulation bell and a static insulation part, wherein external connections including electrical connections, educt gas piping and product gas piping are let through the lower pressure shell part and not through the upper pressure shell part, such that the upper pressure shell part can be lifted from the lower pressure shell part upon opening of the pressure shell flange connection without further disconnection work, and wherein the electrical connections and the product gas piping are let through the static insulation part and not through the insulation bell, such that the insulation bell can be lifted without disconnection work regarding the electrical connections and the product gas piping, when the upper pressure shell part is removed.

2. Solid Oxide Electrolyzer according to claim 1, wherein the insulation bell is open downwards and preferably is made up of one integral piece.

3. Solid Oxide Electrolyzer according to claim 1, wherein the insulation bell is gas tight and structurally stable in itself, wherein the insulation bell consists of a gas tight inner liner, an insulation material layer and an outer structural layer.

4. Solid Oxide Electrolyzer according to claim 1, wherein a position of the static insulation part is fixed in relation to a position of the lower pressure shell part, and wherein a hot zone insulation gasket is arranged on the static insulation part onto which the insulation bell is placed and by which the hot zone is gas tight insulated.

5. Solid Oxide Electrolyzer according to claim 1, wherein the pressure shell flange located at a highest diameter of the Solid Oxide Electrolyzer at or below the position of the hot zone insulation gasket.

6. Solid Oxide Electrolyzer according to claim 1, wherein the Solid Oxide Electrolyzer comprises a recuperating space arranged at least partly around an outside of the hot zone insulation, wherein a first part of the educt gas piping being let through the lower pressure shell part introduces a first educt gas into the recuperating space and wherein the first educt gas exits the recuperating space via a snorkel into a second part of the educt gas piping that leads to the stack module in the hot zone through the static insulation part.

7. Solid Oxide Electrolyzer according to claim 6, wherein the snorkel extends from a connection to the second part of the educt gas piping along and distant from the outside of the hot zone insulation through the recuperating space to a point at or above a top height of the hot zone insulation or the snorkel is led from the connection to the second part of the educt gas piping into the insulation bell and through the insulation bell to the top height of the hot zone insulation, where the snorkel exits the insulation bell into the recuperating space.

8. Solid Oxide Electrolyzer according to claim 1, comprising a Stack module with at least one Solid Oxide electrolysis stack that comprises a plurality of stacked Solid Oxide electrolysis cells, wherein the stack module comprises two gas inlet connections and two gas outlet connections, wherein the at least one Solid Oxide electrolysis stack is encapsulated in a metal container, and wherein the two gas inlet connections and the two gas outlet connections are attached to the metal container.

9. Solid Oxide Electrolyzer according to claim 8, wherein the two gas inlet connections and the two gas outlet connections each comprise hot quick couplings to connect them to external gas inlets or outlets, and wherein the hot quick couplings are configured as piping unions.

10. Solid Oxide Electrolyzer according to claim 8, wherein the stack module comprises two Solid Oxide electrolysis stacks which are manifolded by a shared manifold which is part of the metal container and to which the two gas inlet connections and the two gas outlet connections are attached.

11. Solid Oxide Electrolyzer according to claim 10, wherein the two Solid Oxide electrolysis stacks are placed within respective encapsulating shrouds that form the metal container in combination with the shared manifold and with two lids that are placed in one of the encapsulating shrouds respectively to enclose the Solid Oxide electrolysis stack in the encapsulating shroud.

12. Solid Oxide Electrolyzer according to claim 11, wherein gaskets are placed between the two Solid Oxide electrolysis stacks and the shared manifold and ceramic fiber mats are placed between the two Solid Oxide electrolysis stacks and the respective lid in the encapsulating shroud wherein the lid is fixated to a position in the encapsulating shroud, by welding, and the ceramic fiber mat is configured to exert a compression force onto the respective Solid Oxide electrolysis stack and thereby onto the respective gasket and the shared manifold.

13. Solid Oxide Electrolyzer according to claim 10, wherein the two Solid Oxide electrolysis stacks are arranged on opposite sides of the shared manifold, wherein the two Solid Oxide electrolysis stacks are configured symmetrically towards a symmetry plane trough the shared manifold, which is perpendicular to axes of the encapsulating shrouds, and wherein the shared manifold is also constructed symmetrically to the symmetry plane.

14. Solid Oxide Electrolyzer according to claim 13, wherein each stacked Solid Oxide electrolysis cell comprises two sides, an anode and a cathode side, wherein the two sides are suppliable with different gas streams and wherein the stacked Solid Oxide electrolysis cells are separated by gastight division plates, wherein the shared manifold comprises respective first gas inlets for the two Solid Oxide electrolysis stacks that are supplied by a first of the two gas inlet connections and that lead a first gas stream into respective voids between the encapsulating shrouds and the Solid Oxide electrolysis stacks, wherein the first gas stream then enters volumes between one of the two sides of the respective Solid Oxide electrolysis cells and the respective adjacent division plate and then travels through the volumes towards a centrally placed hole in the respective Solid Oxide electrolysis stack, from where the first gas stream exits the shared manifold through a respective first gas outlet, which is connected to a first of the two gas outlet connections. wherein the shared manifold further comprises second gas inlets for the two Solid Oxide Electrolysis stacks, which are suppliable by a second of the two gas inlet connections with a second gas stream that is lead into a respective hole in the respective Solid Oxide electrolysis stack that extends up through a full stack height, from which the second gas stream enters other volumes between the other side of two sides of the Solid Oxide electrolysis cells and the respective adjacent division plate and then transfers through the other volumes to another hole in the full stack height, from which the second gas stream exits the shared manifold through a second gas outlet, which is connected to a second of the two gas outlet connections.

15. Method of exchanging a stack module of a Solid Oxide Electrolyzer according to claim 1, wherein the method comprises the steps of disconnecting the upper pressure shell part from the lower pressure shell part by opening the pressure shell flange connection, lifting the upper pressure shell part away from lower pressure shell part and thereby exposing the insulation bell, lifting the insulation bell away and thereby exposing the stack module, disconnecting the stack module from all connections to the Solid Oxide Electrolyzer replacing the stack module reconnecting the stack module with the connections to the Solid Oxide Electrolyzer, and closing the Solid Oxide Electrolyzer by repositioning the insulation bell and the upper pressure shell.
